(19) United States
(12) Patent Application Publication
(10) Pub. No.: US 2018/0287931 A1
(43) Pub. Date: Oct. 4, 2018

(54) Provisioning a Network Node for Attribute Sharing

(71) Applicant: Microsoft Technology Licensing, LLC, Redmond, WA (US)

(72) Inventors: Gareth L. E. Bridges, Redmond, WA (US); Amer Aref Hassan, Kirkland, WA (US); Timothy Mark Moore, Bellevue, WA (US)

(73) Assignee: Microsoft Technology Licensing, LLC, Redmond, WA (US)

(21) Appl. No.: 15/471,844

(22) Filed: Mar. 28, 2017

(51) Int. Cl. H04L 12/725; H04L 12/24; H04L 12/753

(52) U.S. Cl. CPC H04L 45/302; H04L 41/0806; H04L 45/3065; H04L 45/306; H04L 45/48

(57) ABSTRACT

Techniques for provisioning a network node for attribute sharing are described. According to various implementations, a cloud-based connectivity service maintains network path information that identifies routing paths for routing communication sessions across different networks. The connectivity service also tracks whether particular network nodes across the different paths are provisioned with an attribute sharing functionality. An entity such as a communication service and/or a client device can query the connectivity service for a routing path for routing a communication session, and the connectivity service can respond identifying a routing path. In at least some implementations, the connectivity service selects a routing path based on a historical and/or real-time signal quality for the routing path.

### BACKGROUND

Modern communication systems have an array of capabilities, including integration of various communication modalities with different services. For example, voice/video communications, instant messaging, data/application sharing, white-boarding, and other forms of communication may be combined with presence and availability information for users. Such systems enable users to engage in communication sessions to exchange different types of communication media, such as voice data, video data, content sharing, and combinations thereof. Furthermore, collaboration systems that enable users to share and collaborate in creating and modifying various types of documents and content may be integrated with multimodal communication systems providing different kinds of communication and collaboration capabilities. Such integrated systems are sometimes referred to as Unified Communication (UC) systems.

While UC systems provide for increased flexibility in communications, they also present a number of implementation challenges. For instance, determining optimal networks for transmitting UC data is difficult since devices involved in UC sessions are typically unaware of network attributes. Further, UC is typically implemented via software that can be loaded on mobile devices, e.g., tablets, smartphones, laptops, and so forth. Thus, techniques for managing UC communication traffic typically have to be fluid and dynamic to accommodate changing connection scenarios.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques for provisioning a network node for attribute sharing are described. According to various implementations, a cloud-based connectivity service maintains network path information that identifies routing paths for routing communication sessions across different networks. The connectivity service also tracks whether particular network nodes across the different paths are provisioned with an attribute sharing functionality. An entity such as a communication service and/or a client device can query the connectivity service for a routing path for routing a communication session, and the connectivity service can respond identifying a routing path. In at least some implementations, the connectivity service selects a routing path based on a historical and/or real-time signal quality for the routing path.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques discussed herein.

FIG. 2 depicts an example implementation scenario for determining a routing path for a communication session in accordance with one or more implementations.

FIG. 3 depicts an example implementation scenario for provisioning network nodes with attribute sharing functionality in accordance with one or more implementations.

FIG. 4 depicts an example implementation scenario for sharing information pertaining to a communication session in accordance with one or more implementations.

FIG. 5 depicts an example implementation scenario for deprovisioning sharing functionality in accordance with one or more implementations.

FIG. 6 depicts different sources of communication-related attributes in accordance with one or more implementations.

FIG. 7 is a flow diagram that describes steps in a method for providing path information for a communication session in accordance with one or more implementations.

FIG. 8 is a flow diagram that describes steps in a method for updating a path record for a routing path in accordance with one or more implementations.

FIG. 9 is a flow diagram that describes steps in a method for updating a path record for a routing path in accordance with one or more implementations.

FIG. 10 is a flow diagram that describes steps in a method for causing a network node to be provisioned with attribute sharing functionality in accordance with one or more implementations.

FIG. 11 is a flow diagram that describes steps in a method for using attribute sharing functionality for sharing an attribute of a communication session in accordance with one or more implementations.

FIG. 12 is a flow diagram that describes steps in a method for deprovisioning an attribute sharing functionality from a network node in accordance with one or more implementations.

FIG. 13 illustrates an example system and computing device as described with reference to FIG. 1, which are configured to implement implementations of techniques described herein.

### DETAILED DESCRIPTION

Techniques for provisioning a network node for attribute sharing are described. According to various implementations, a cloud-based connectivity service maintains network path information that identifies routing paths for routing communication sessions across different networks. Examples of a communication session include a Voice over Internet Protocol (VoIP) call, a video call, text messaging, a file transfer, and/or combinations thereof. A communication session, for instance, is typically implemented via Internet Protocol (IP).

The connectivity service also tracks whether particular network nodes across the different paths are provisioned with an attribute sharing functionality. An entity such as a communication service and/or a client device can query the connectivity service for a routing path for routing a communication session, and the connectivity service can respond identifying a routing path. In at least some implementations, the connectivity service selects a routing path based on a historical and/or real-time signal quality for the routing path.

According to various implementations, when the connectivity service indicates that a particular network node along a selected routing path is not provisioned with an attribute sharing functionality, a provisioning procedure is implement to provision the attribute sharing functionality to the network node. Thus, the network node can leverage the attribute sharing functionality to propagate various attributes pertaining to a communication session to various entities involved in the communication session. Examples of such attributes include signal quality experienced across a routing path, identifiers for devices involved in a communication session, errors detected across a routing path, and so forth. For instance, when attributes pertaining to a communication session indicate that signal quality across a particular routing path is poor, an optimization procedure can be implemented to attempt to increase signal quality. In one particular example, a different routing path can be selected for rerouting the communication session.

Thus, techniques described herein enable signal quality for communication sessions to be optimized by allowing various attributes pertaining to communication sessions to be shared between different entities involved in the communication sessions.

In the following discussion, an example environment is first described that is operable to employ techniques described herein. Next, a section entitled “Example Implementation Scenarios” describes some example implementation scenarios in accordance with one or more implementations. Following this, a section entitled “Example Procedures” describes some example procedures in accordance with one or more implementations. Finally, a section entitled “Example System and Device” describes an example system and device that are operable to employ techniques discussed herein in accordance with one or more implementations.

Having presented an overview of example implementations in accordance with one or more implementations, consider now an example environment in which example implementations may by employed.

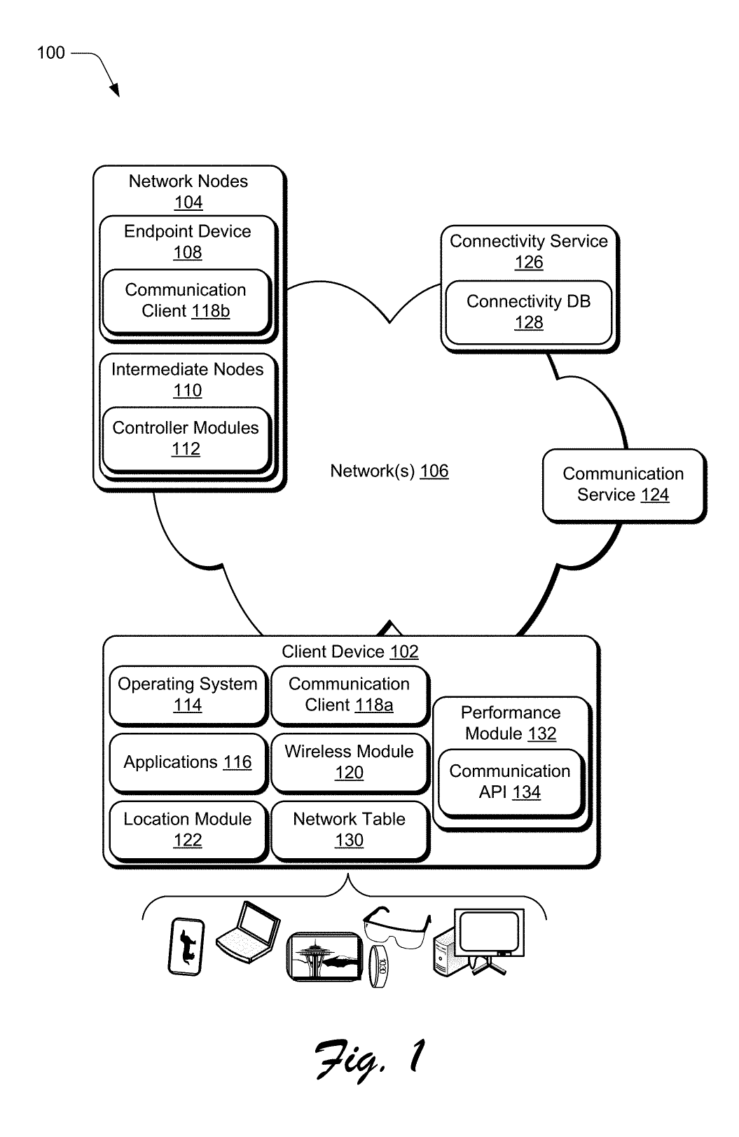

FIG. 1 is an illustration of an environment 100 in an example implementation that is operable to employ techniques provisioning a network node for attribute sharing described herein. Generally, the environment 100 includes various devices, services, and networks that enable communication via a variety of different modalities. For instance, the environment 100 includes a client device 102 and network nodes 104 connected to networks 106. Further, the network nodes 104 include an endpoint device 108 and intermediate nodes 110. The client device 102 and the endpoint device 108 may be configured in a variety of ways, such as a traditional computer (e.g., a desktop personal computer, laptop computer, and so on), a mobile station, an entertainment appliance, a smartphone, a wearable device, a netbook, a game console, a handheld device (e.g., a tablet), and so forth.

The intermediate nodes 110 are representative of various infrastructure components that manage network functionality of the networks 106 and/or distribute and redistribute data that is transmitted over the networks 106. Examples of the intermediate nodes 110 include a network controller, a router, a switch, a gateway, a wireless access point (WAP), a session border controller (SBC), and so forth. The intermediate nodes 110 include controller modules 112, which are representative of functionality for controlling operation of the different intermediate nodes 110. The controller modules 112, for example, represent operating systems for the intermediate nodes 110. In at least some implementations, the networks 106 include a software defined network (SDN), and the controller module 112 for the SDN represents an SDN controller for the SDN. According to one or more implementations, each intermediate node 110 includes a different respective instance of the controller modules 112.

The networks 106 provide the client device 102 and the network nodes 104 with connectivity to various networks and/or services, such as the Internet. The networks 106, for instance, enable data to be transmitted via a wired and/or wireless connection between the client device 102 and the network nodes 104. The networks 106 may be implemented via a variety of different instances and combinations of connectivity technologies, such as wireless cellular, broadband cable, digital subscriber line (DSL), wireless data connectivity (e.g., WiFi™), T-carrier (e.g., T1), Ethernet, and so forth. In at least some implementations, the networks 106 represent different interconnected wired and wireless networks.

The client device 102 includes a variety of different functionalities that enable various activities and tasks to be performed. For instance, the client device 102 includes an operating system 114, applications 116, a communication client 118a, a wireless module 120, and a location module 122. Generally, the operating system 114 is representative of functionality for abstracting various system components of the client device 102, such as hardware, kernel-level modules and services, and so forth. The operating system 114, for instance, can abstract various components of the client device 102 to the applications 116 to enable interaction between the components and the applications 116.

The applications 116 represent functionalities for performing different tasks via the client device 102. Examples of the applications 116 include a word processing application, a spreadsheet application, a web browser, a gaming application, and so forth. The applications 116 may be installed locally on the client device 102 to be executed via a local runtime environment, and/or may represent portals to remote functionality, such as cloud-based services, web apps, and so forth. Thus, the applications 116 may take a variety of forms, such as locally-executed code, portals to remotely hosted services, and so forth.

The communication client 118a is representative of functionality to enable different forms of communication via the client device 102, such as for communication between the client device 102 and the endpoint device 108. Examples of the communication client 118a include a voice communication application (e.g., a VoIP client), a UC client, a video communication application, a messaging application, a content sharing application, and combinations thereof. The communication client 118a, for instance, enables different communication modalities to be combined to provide diverse communication scenarios. In at least some implementations, the communication client 118a represents an application that is installed on the client device 102. Additionally or alternatively, the communication client 118a can be implemented as a portal to a remote application, such as accessed via a web browser, a web application, and so forth.

According to one or more implementations, communication between the client device 102 and the endpoint device 108 occurs between the communication client 118a and a communication client 118b of the endpoint device 108. The communication client 118b, for instance, represents an instance of the communication client 118a. For example, a communication session between the client device 102 and the endpoint device 108 represents an exchange of communication media between the communication client 118a and the communication client 118b. In at least some implementations, the communication clients 118a, 118b represent applications that execute at an application layer of their respective devices.

The wireless module 120 of the client device 102 is representative of functionality for enabling the client device 102 to communicate data wirelessly over the networks 106. For instance, the wireless module 120 represents hardware and logic for data communication over the networks 106 via a variety of different wireless technologies and protocols.

The wireless module 120 includes other components not expressly illustrated herein, such as an encryption module for encrypting and decrypting data, a radio frequency (RF) modulator for modulating and demodulating data, RF components (e.g., antennas, radios, and so forth) for transmitting and receiving RF signal, a codec for encoding and decoding data, and so forth.

The location module 122 is representative of functionality to determine a location of the client device 102. For example, the location module 122 may receive location information from one or more external location systems, such as Global Positioning System (GPS) coordinates from one or more GPS satellites, location information from a wireless cellular service, map information from a mapping service, and so forth. The location module 122 may provide such location information to other entities and functionalities, such as the various functionalities and entities discussed in the environment 100. As further detailed herein, location information may be utilized to identify preferred networks at a particular location for the client device 102.

The environment 100 further includes a communication service 124, which is representative of a service to perform various tasks for management of communication between the client device 102 and the endpoint device 108. The communication service 124, for instance, can manage initiation, moderation, and termination of communication sessions. Examples of the communication service 124 include a VoIP service, an online conferencing service, a UC service, and so forth. In at least some implementations, the communication service 124 may be implemented as or be connected to a private branch exchange (PBX) in communication with a Public Switched Telephone Network (“PSTN”) to enable voice communication between the client device 102 and the endpoint device 108.

According to one or more implementations, the communication clients 118a, 118b are managed and/or hosted by the communication service 124. For instance, the communication clients 118a, 118b represent interfaces to communication services provided by the communication service 124.

The environment 100 further includes a connectivity service 126, which is representative of a network-based (e.g., cloud-based) service that provides network intelligence to various entities. For instance, the connectivity service 126 provides network intelligence to the communication service 124, the client device 102, and/or the network nodes 104. The connectivity service 126 maintains a connectivity database (DB) 128, which is representative of functionality for storing various network parameters and other information pertaining to network connectivity. Examples of different types of network information stored in the connectivity DB 128 are discussed below.

According to various implementations, the connectivity service 126 provides connectivity data from the connectivity DB 128 to the communication service 124, which forwards the connectivity data to the client device 102. The client device 102 stores the connectivity data as part of a network table 130, and the wireless module 120 utilizes the connectivity data to establish a connection to a particular network 106. The network connection, for instance, is utilized for transmission of data as part of a communication session between the client device 102 and the endpoint device 108.

In at least some implementations, the connectivity service 126 represents a service that is implemented and managed by the communication service 124. Alternatively, the connectivity service 126 represents a standalone service that provides intelligence pertaining to networks to a variety of different services and/or devices.

To enable various types of communication-related data to be shared between various entities, the client device 102 includes a performance module 132 which is representative of functionality for receiving communication attributes from other entities, and for sharing communication attributes with other entities. According to various implementations, the performance module 132 utilizes a communication application programming interface (API) 134 to enable various communication attributes to be shared. The communication API 134, for example, can be populated with various communication attributes to enable the communication attributes to be shared with various entities involved in communication sessions. As further detailed below, instances of the performance module 132 can be propagated to the various network nodes 104 to enable the network nodes 104 to participate in sharing communication attributes with other entities, such as the client device 102.

The different entities and functionalities discussed in the environment 100 may be implemented in software, hardware, firmware, and/or combinations thereof. Further details and implementations of the various entities of the environment 100 are discussed below.

Having described an example environment in which the techniques described herein may operate, consider now a discussion of example ways of propagating routing awareness in accordance with one or more implementations.

According to various implementations, techniques can be employed to dynamically enlighten various entities with communication attributes, such as information about network conditions, information about communication sessions, and so forth. For instance, the performance module 132 can leverage the communication API 134 to generate notification events that include various attributes of networks and communication sessions. The notification events can be propagated to different entities further to techniques for provisioning a network node for attribute sharing discussed herein.

In at least some implementations, the communication API 134 can be populated with values for sets of communication attributes based on various network and/or node conditions. Consider, for instance, the following communication attributes that may be conveyed via a notification event generated using the communication API 134.

Network Identifiers: This attribute can be leveraged to identify networks, such as networks that a communication session traverses between a client device 102 and an endpoint device 108. In at least some implementations, the network identifier may include an autonomous system (AS) number that identifies a particular network. With reference to the environment 100, for instance, the network identifier may identify a particular network included in the networks 106.

Timestamp: This attribute can be leveraged to specify timestamps for a start of a communication session, updates that occur during a communication session, and an end (e.g., termination) of a communication session.

Source IP Address: This attribute can be leveraged to specify an IP address for a device that is a source of media during a communication session, e.g., a device that initiates a communication session. With reference to the environment 100, for instance, the source IP address may be for a client device 102 or an endpoint device 108.

Destination IP Address: This attribute can be leveraged to specify an IP address for a device that receives media as part of a communication session. With reference to the environment 100, for instance, a destination IP address may be for an endpoint device 108.

Device Identifier: This attribute can be used to identify source and/or destination devices involved in a communication session using a hardware-specific identifier, such as a media access control (MAC) address and/or other unique hardware identifier.

Transport Type: This attribute can be leveraged to specify a transport type or combination of transport types for a communication session. Examples of transport types include Transmission Control Protocol (TCP), User Datagram Protocol (UDP), and so forth.

Source Port: this attribute can be leveraged to specify an identifier for a port at a source device, e.g., a source device identified by the Source IP Address referenced above.

Destination Port: This attribute can be leveraged to specify an identifier for a port at a destination device, e.g., a destination device identified by the Destination IP Address referenced above.

Media Type: This attribute can be leveraged to specify a media type and/or types that are transmitted and/or are being transmitted as part of a communication session. A communication session can involve multiple different types of media, such as audio, video, images, and combinations thereof. Thus, the Media Type attribute can be employed to identify media types in a communication session.

Bandwidth Estimation: This attribute can be leveraged to specify an estimated bandwidth used for a communication session.

To: This attribute can be leveraged to identify a user to which media in a communication session is transmitted.

From: This attribute can be leveraged to identify a user from which media in a communication session is transmitted.

Codec: This attribute can be leveraged to specify a codec or codecs utilized as part of a communication session.

Subnet: This attribute can be leveraged to identify a subnetwork and/or set of subnetworks that a communication session is originated in and/or traverses.

Personally Identifiable Information (PII): This attribute can be used to specify particular types of PII that are to be included and/or not included with a subscription to communication attributes. For instance, the PII attributes can be used to specify that no PII is to be included in a set of communication attributes. As another example, the PII attributes can be used to specify that a particular set of PII is to be included, whereas a different set of PII is to be excluded.

Error Code: This attribute can be leveraged to specify various error codes for errors that may occur as part of a communication session. For example, errors can include errors that occur during initiation the communication session, errors that occurred during a communication session, errors that occur when a communication session is terminated, and so forth.

Mean Opinion Score (MOS) Degradation: This attribute can be leveraged to specify a MOS for a communication session. The attribute, for instance, can be used to indicate that an overall quality of a communication session has decreased.

Jitter Inter-Arrival Time: This attribute can be leveraged to specify jitter values for a communication session. The attribute, for instance, can be used to indicate that a jitter value or values have increased, e.g., have exceeded a specified jitter value threshold.

Packet Loss Rate: This attribute can be leveraged to specify a packet loss rate for a communication session. The attribute, for instance, can be used to indicate that a packet loss rate has increased, e.g., has exceeded a specified packet loss rate value threshold.

Round Trip Delay (RTD): This attribute can be leveraged to specify RTD values for packets in communication sessions. The attribute, for instance, can be used to indicate that RTD values for packets have increased, e.g., have exceeded a specified RTD value threshold.

Concealment Ratio: This attribute can be leveraged to specify a cumulative ratio of concealment time over speech time observed after starting a communication session. The attribute, for instance, can be used to specify that a concealment ratio has increased, e.g., has exceeded a specified concealment ratio value threshold.

These particular attributes are presented for purpose of example only, and it is to be appreciated that a variety of other communication attributes not expressly mentioned herein can be shared according to techniques for provisioning a network node for attribute sharing. In at least some implementations, attributes can be linked to particular networks and/or network components to characterize performance attributes of the networks and/or network components. Further, an entity that receives values for communication attributes via the communication API 134 can utilize the attributes to optimize network and/or communication session performance.

Having described an example ways of propagating communication attributes, consider now some example implementation scenarios for propagating communication attributes in accordance with one or more implementations.

The following section describes an example implementation scenarios for provisioning a network node for attribute sharing in accordance with one or more implementations. The implementation scenarios may be implemented in the environment 100 discussed above, and/or any other suitable environment.

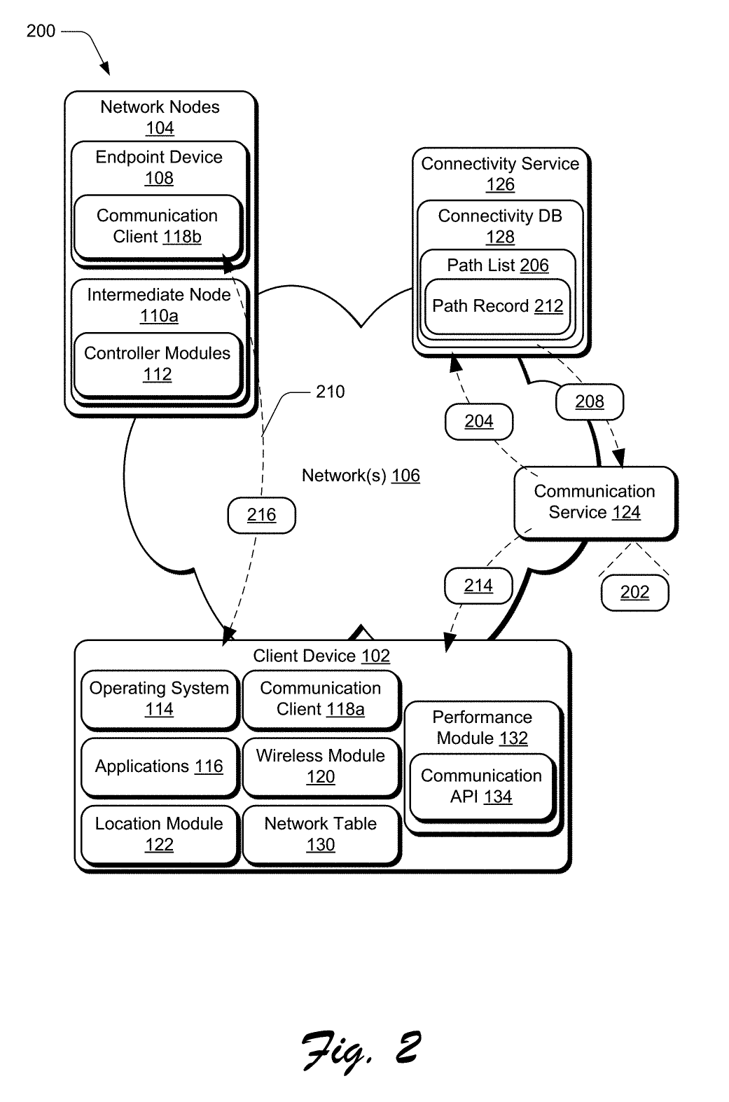

FIG. 2 depicts an example implementation scenario 200 for determining a routing path for a communication session in accordance with one or more implementations.

In the scenario 200, the communication service 124 detects a notification event 202 which indicates that a communication session is initiated or is scheduled to be initiated between the client device 102 and the endpoint device 108. Generally, the notification event 202 can be implemented in various ways. For instance, the notification event 202 can occur in response to detecting that a user of the client device 102 performs an action to initiate a communication session with the endpoint device 108, such as dialing a phone number or selecting a call control functionality to initiate a communication session with the endpoint device 108.

Alternatively, the notification event 202 can occur in response to detecting an upcoming scheduled communication session. For instance, the communication client 118a on the client device 102 detects a scheduled upcoming calendar event that involves a communication session. Thus, the notification event 202 can occur responsive to a real-time initiation of a communication session, and/or proactively based on a scheduled communication session that has not yet started.

Accordingly, the communication service 124 transmits a routing query 204 to the connectivity service 126. Generally, the routing query 204 includes various information pertaining to the communication session, such as an identifier for the client device 102, an identifier for the endpoint device 108, media type(s) involved in the communication session, and so forth. In at least some implementations, the routing query 204 is generated using the communication API 134 introduced above.

Based on the routing query 204, the connectivity service 126 determines routing attributes for routing the communication session between the client device 102 and the endpoint device 108. The connectivity DB 128, for example, includes a path list 206 that identifies different routing paths and routing paths attributes for routing data across the networks 106 between the client device 102 and the endpoint device 108. Routing paths can be identified in the path list 206 in various ways, such as via network identifiers for networks along each routing path, identifiers for intermediate nodes 110 along each routing path, a network destination identifier such as a uniform resource identifier (URI), and so forth.

In at least some implementations, the path list 206 indicates signal quality for different routing paths and/or network nodes along different routing paths. Generally, the connectivity service 126 can determine signal quality in various ways, such as via quality-related feedback from endpoints that communicate along different routing paths, via communication of quality information from network nodes 104 along different routing paths, via direct detection of signal quality along different routing paths, and so forth. For instance, and as further detailed below, synthetic transactions can be implemented that test signal quality along different routing paths over the networks 106.

According to various implementations, the path list 206 indicates whether particular network nodes 104 along different routing paths are provisioned with the performance module 132. The path list 206, for example, can be leveraged to identify different routing paths between the client device 102 and the endpoint device 108, and whether network nodes 104 on the different routing paths are provisioned with the performance module 132.

Continuing with the scenario 200, the connectivity service 126 generates a routing response 208 that includes routing path attributes for routing a communication session between the client device 102 and the endpoint device 108. The routing response 208, for example, identifies a candidate path 210 for routing a communication session between the client device 102 and the endpoint device 108. In at least some implementations, the candidate path 210 is selected as a routing path that is identified in the connectivity DB 128 as having a highest available signal quality for transmitting signal between the client device 102 and the endpoint device 108. The candidate path 210 is represented in the path list 206 via a path record 212. Generally, the path record 212 tracks different information about the candidate path 210, such as identifiers for network nodes 104 along the candidate path 210, quality information for the candidate path 210, and whether particular network nodes 104 along the candidate path 210 are provisioned with the performance module 132.

Alternatively or additionally, the routing response 208 identifies a list of available routing paths including the candidate path 210 for routing a communication session between the client device 102 and the endpoint device 108. The list, for instance, may indicate a relative signal quality for each candidate routing path. For example, the list can represent a ranked list of available routing paths, such as ranked from highest signal quality to lowest signal quality.

In this particular implementation, the routing response 208 identifies the candidate path 210 and indicates that an intermediate node 110a along the candidate path 210 is not provisioned with the performance module 132. The routing response 208 also indicates that the endpoint device 108 is not provisioned with the performance module 132.

Continuing with the scenario 200, the connectivity service 126 communicates the routing response 208 to the communication service 124. The communication service 124 processes the routing response 208 to identify the candidate path 210 and to ascertain that the intermediate node 110a and the endpoint device 108 are not provisioned with the performance module 132. Accordingly, and as detailed in the following scenario, the communication service 124 initiates a provisioning procedure to provision the intermediate node 110a and the endpoint device 108 with the performance module 132.

To enable the client device 102 to utilize the candidate path 210, the communication service 124 communicates a session notification 214 to the client device 102. Generally, the session notification 214 identifies the candidate path 210, such as via network identifiers and/or identifiers for intermediate nodes 110 along the candidate path. Accordingly, the client device 102 utilizes the candidate path 210 to route a communication session 216.

In an example implementation, the communication session 216 is already in progress over a different routing path when the client device 102 receives the session notification 214. Thus, the client device 102 can reroute the communication session 216 from the different routing path to the candidate path 210. Alternatively, the communication session 216 has not yet started when the client device 102 receives the session notification 214, and thus the client device 102 can initiate the communication session 216 over the candidate path 210.

As mentioned above, a process is initiated to cause the intermediate node 110a and the endpoint device 108 to be provisioned with the performance module 132. Consider, for example, the following scenario.

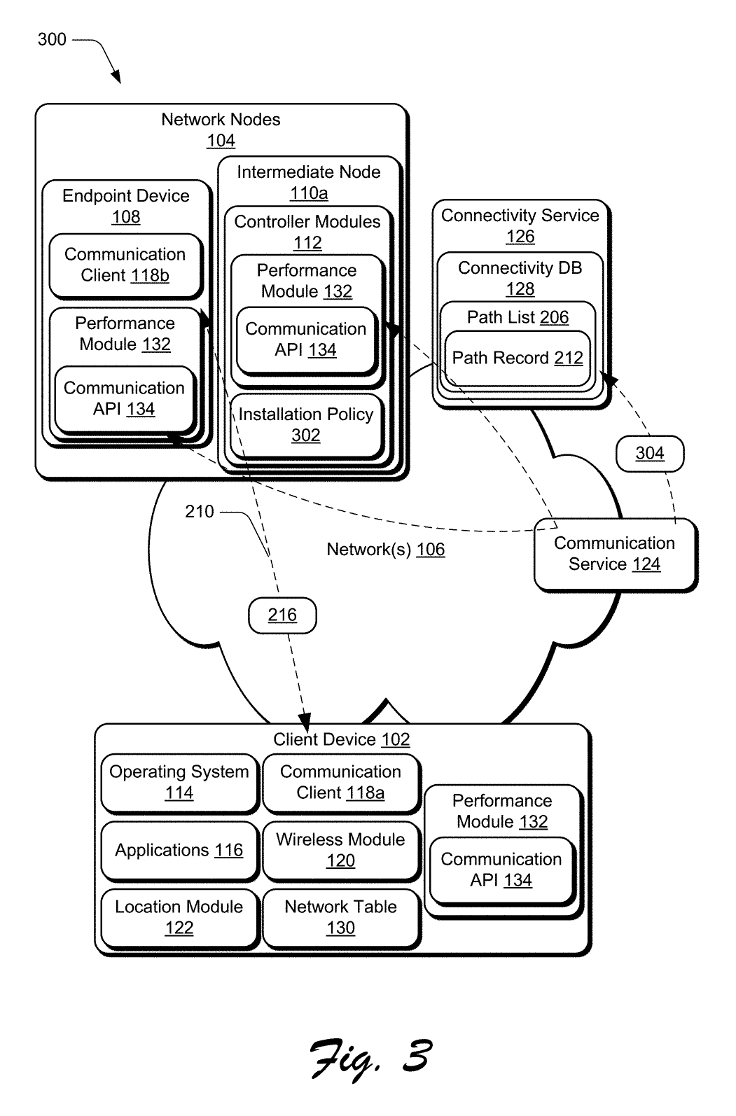

FIG. 3 depicts an example implementation scenario 300 for provisioning network nodes with attribute sharing functionality in accordance with one or more implementations. The scenario 300, for instance, represents a continuation and/or variation of the scenario 200 described above.

In the scenario 300, the communication service 124 has received the routing response 208 which identifies the candidate path 210 and indicates that the intermediate node 110a and the endpoint device 108 are not provisioned with the performance module 132. Accordingly, the communication service 124 communicates instances of the performance module 132 to the intermediate node 110a and the endpoint device 108.

According to various implementations, the intermediate node 110a receives the performance module 132, and a controller module 112a for the intermediate node 110a initiates an installation of the performance module 132. The performance module 132, for example, includes executable functionality that can be executed by the controller module 112a to perform various aspects of provisioning a network node for attribute sharing described herein. Further, the performance module 132 includes the communication API 134, which enables various communication-related attributes to be shared between devices involved in communication sessions.

As depicted in the scenario 300, the controller module 112a includes an installation policy 302, which represents a policy that specifies conditions for installing the performance module 132 on the intermediate node 110a. The installation policy 302, for example, specifies an installation duration for the performance module 132 on the intermediate node 110a, e.g., a period of time during which the performance module 132a is permitted to remain installed on the intermediate node 110a. In at least some implementations, the installation policy 302 may specify a discrete period of time during which the performance module 132a is permitted to remain installed on the intermediate node 110a, such as 2 hours, 24 hours, 2 days, and so forth.

Alternatively or additionally, the installation policy 302 may specify specific events that cause the performance module 132 to be uninstalled from the intermediate node 110a. Examples of such events include a termination of the communication session 216, an uninstall notification (e.g., from the communication service 124), a device resource event (e.g., available memory on the intermediate node falling below a threshold amount), and so forth. Accordingly, the performance module 132 is installed on the intermediate node 110a subject to conditions specified by the installation policy 302.

Further to the scenario 300, the performance module 132 is also installed on the endpoint device 108. The performance module 132, for example, is installed as an auxiliary functionality of the communication client 118b, or as a separate functionality that is accessible to the communication client 118b.

Accordingly, the controller module 112a and the endpoint device 108 can utilize the performance module 132 to send and receive information pertaining to the communication session 216 that occurs over the candidate path 210. Generally, the communication session 216 can be initiated before, concurrently with, or after installation of the performance module 132 on the intermediate node 110a and the endpoint device 108. According to various implementations, the communication session 216 represents an exchange of communication media between the client device 102 and the endpoint device 108 over the candidate path 210, such as audio, video, content (e.g., files), and/or combinations thereof.

Further to the scenario 300, the communication service 124 communicates a provisioning notification 304 to the connectivity service 126 indicating that the intermediate node 110a and the endpoint device 108 are provisioned with the performance module 132. In at least some implementations, the provisioning notification 304 may also indicate conditions under which the performance module 132 is provisioned on the intermediate node 110a, such as a duration of the installation indicated by the installation policy 302. Accordingly, the connectivity service 126 updates the path record 212 to indicate that the intermediate node 110a and the endpoint device 108 are provisioned with the performance module 132, and to reflect conditions under which the performance module 132 is provisioned on the intermediate node 110a. For example, the path record 212 indicates a time at which installation of the performance module 132 on the intermediate node 110a will expire, e.g., a time at which the performance module 132 will be uninstalled from the intermediate node 110a. Accordingly, a subsequent query to the connectivity service 126 for path information over the networks 106 will return an indication that the intermediate node 110a and the endpoint device 108 are provisioned with the performance module 132, and a duration of the provisioning on the intermediate node 110a.

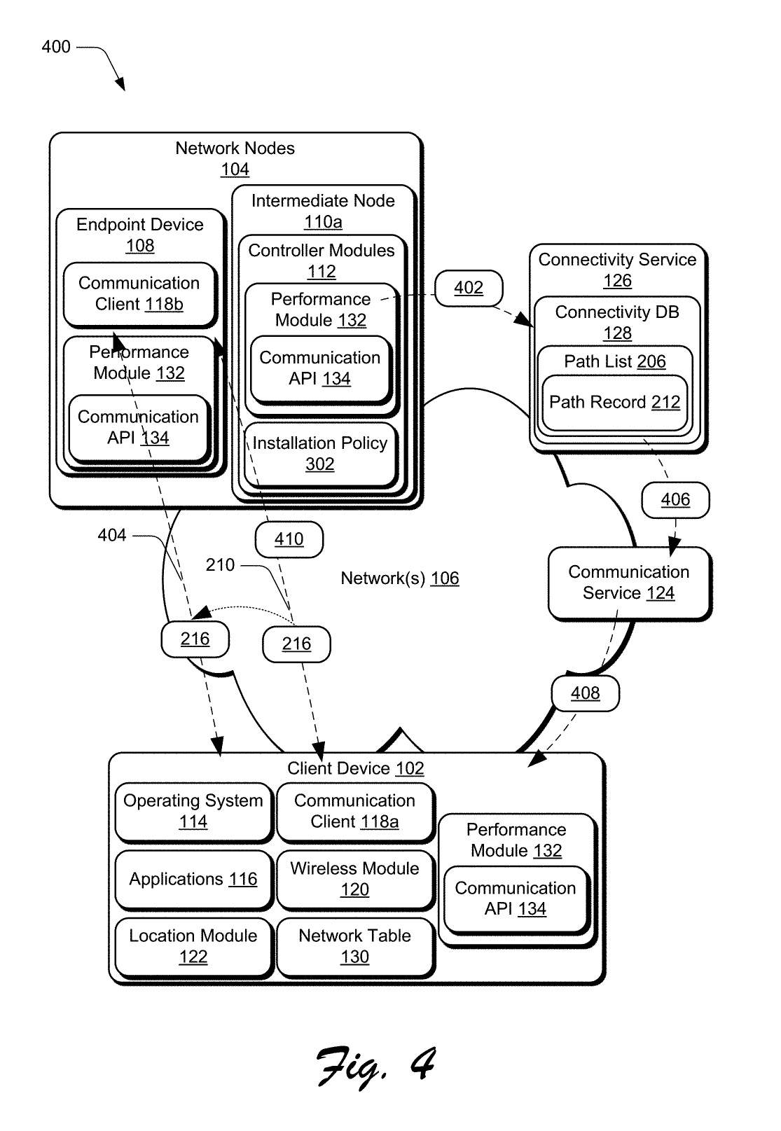

FIG. 4 depicts an example implementation scenario 400 for sharing information pertaining to a communication session in accordance with one or more implementations. The scenario 400, for instance, represents a continuation of and/or variation on the scenarios 200, 300 described above.

In the scenario 400, the controller module 112a on the intermediate node 110a utilizes the performance module 132 to communicate performance information 402 to the connectivity service 126. The performance information 402, for example, is configured using the communication API 134, such as by populating values to various attributes defined by the communication API 134. Generally, the performance information 402 identifies the candidate path 210 and includes various information pertaining to the communication session 216, such as different quality-related parameters for data of the communication session 216. Examples of quality-related parameters include MOS degradation, jitter, packet loss rate, round trip delay, concealment ratio, and so forth, for data of the communication session 216 as transmitted over the candidate path 210. The performance module 132, for example, detects quality-related attributes of the communication session 216, and utilizes the communication API 134 to communicate the quality-related attributes as part of the performance information 402.

The connectivity service 126 receives the performance information 402 and updates the path record 212 for the candidate path 210 with the performance information 402. The path record 212, for example, is updated to indicate a signal quality across the candidate path 210, available bandwidth across the candidate path 210, and so forth. For instance, the connectivity service 126 ascertains a relative signal quality of the candidate path 210 based on the performance information 402, and updates the path record 212 to reflect the relative signal quality. According to various implementations, if the performance information 402 indicates that data errors detected as part of the communication session 216 are below a threshold number of errors, the path record 212 is updated to reflect that the candidate path 210 has an acceptable or high signal quality. However, if the performance information 402 indicates that data errors detected as part of the communication session 216 are above a threshold number of errors, the path record 212 is updated to reflect that the candidate path 210 has low signal quality. Alternatively or additionally, the performance information 402 can include user feedback indicating a relative quality of experience for the communication session 216 (e.g., high, acceptable, poor, and so forth), and the path record 212 is updated to reflect the relative quality of experience.

According to various implementations, the connectivity service 126 can utilize the updated path record 212 in different ways. For instance, if the performance information 402 indicates that signal quality across the candidate path 210 is below a threshold signal quality, the candidate path 210 can be removed from the path list 206 of available routing paths across the networks 106. If the performance information 402 indicates that the signal quality is high, however, the candidate path 210 can be designated in the path list 206 as a high quality path.

In at least some implementations, routing paths in the path list 206 are ranked based on relative signal quality, such as from highest signal quality to lowest signal quality. Thus, if the performance information 402 indicates that signal quality of the candidate path 210 has changed from a previously-indicated signal quality, the candidate path 210 can be re-ranked in the path list 206. For instance, if signal quality across the candidate path 210 has increased from a previously-known signal quality, the candidate path 210 can be re-ranked in the path list 206 above other candidate paths that have lower signal quality. If signal quality across the candidate path 210 has decreased from a previously-known signal quality, however, the candidate path 210 can be re-ranked in the path list 206 below other candidate paths that have higher signal quality.

In this particular scenario, the performance information 402 indicates that signal quality across the candidate path 210 is low, such as based on errors detected in signal used to communicate the communication session 216 across the candidate path 210. Accordingly, the connectivity service 126 identifies an updated path 404 from the path list 206 for routing the communication session 216 between the client device 102 and the endpoint device 108. The updated path 404, for example, is indicated in the path list 206 as having a high signal quality, such as based on information and/or feedback from a different network node 104. The connectivity service 126 communicates an update notification 406 that identifies the updated path 404 to the communication service 124, which then communicates a path notification 408 identifying the updated path 404 to the client device 102. Alternatively, the connectivity service 126 can communicate the update notification 406 directly to the client device 102.

After receiving the path notification 408, the client device 102 reroutes the communication session 216 from the candidate path 210 to the updated path 404. Generally, this represents an attempt to improve and/or optimize the signal quality of the communication session 216.

As an alternative or additional implementation to collecting the performance information 402 based on the communication session 216, the performance information 402 can be based on a synthetic transaction 410 that is performed over the candidate path 210. Generally, the synthetic transaction 410 represents a test procedure that is performed to determine quality-related attributes of the candidate path 210. The synthetic transaction 410, for example, is performed by the performance module 132 that resides on the client device 102, the intermediate node 110a, and/or the endpoint device 108. The synthetic transaction 410 includes various types of test data, such as simulated and/or actual voice data, video data, content files, and so forth. According to various implementations, the synthetic transaction 410 is separate from a real-time exchange of communication media between the client device 102 and the endpoint device 108, e.g., the communication session 216. The synthetic transaction 410, however, may be performed prior to and/or in preparation for the communication session 216, such as to test signal quality across the candidate path 210. In such an implementation, if the performance information 402 generated based on the synthetic transaction 410 indicates that the signal quality of the candidate path 210 is low, the candidate path 210 can be replaced with the updated path 404 prior to initiation of the communication session 216.

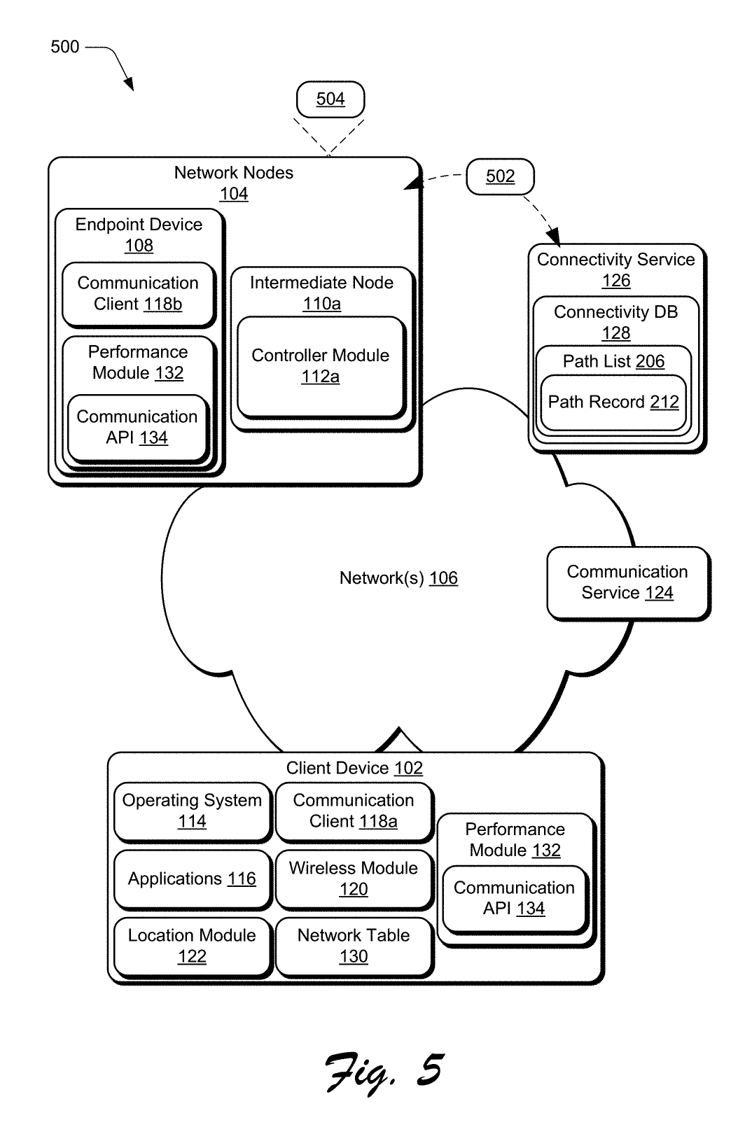

FIG. 5 depicts an example implementation scenario 500 for deprovisioning sharing functionality in accordance with one or more implementations. The scenario 500, for instance, represents a continuation of and/or variation on the scenarios 200-400 described above.

In the scenario 500, a deprovisioning event 502 occurs that causes the performance module 132 to be deprovisioned from the intermediate node 110a. The deprovisioning event 502 can take various forms, such as an expiration of a provisioning time period specified by the installation policy 302, a termination of the communication session 216, a user-initiated event (e.g., by an Information Technology (IT) personnel), and so forth. Thus, in response to the deprovisioning event 502, a deprovisioning process 504 is performed on the intermediate node 110a for the performance module 132. Generally, the deprovisioning process 504 can be performed in various ways, such as by uninstalling the performance module 132 from the intermediate node 110a and/or deactivating functionality of the performance module 132 on the intermediate node 110a. Based on the deprovisioning process 504, the performance module 132 is no longer active on the intermediate node 110a unless the performance module 132 is again provisioned on the intermediate node 110a.

Further to the scenario 500, the connectivity service 126 updates the path list 206 to indicate that the intermediate node 110a is not provisioned with the performance module 132. The path record 212, for example, is revised to indicate that the intermediate node 110a is not provisioned with the performance module 132. Thus, a subsequent communication from the connectivity service 126 identifying the candidate path 210 will indicate that the intermediate node 110a is not provisioned with the performance module 132, unless the intermediate node 110a is again provisioned with the performance module 132, such as described above.

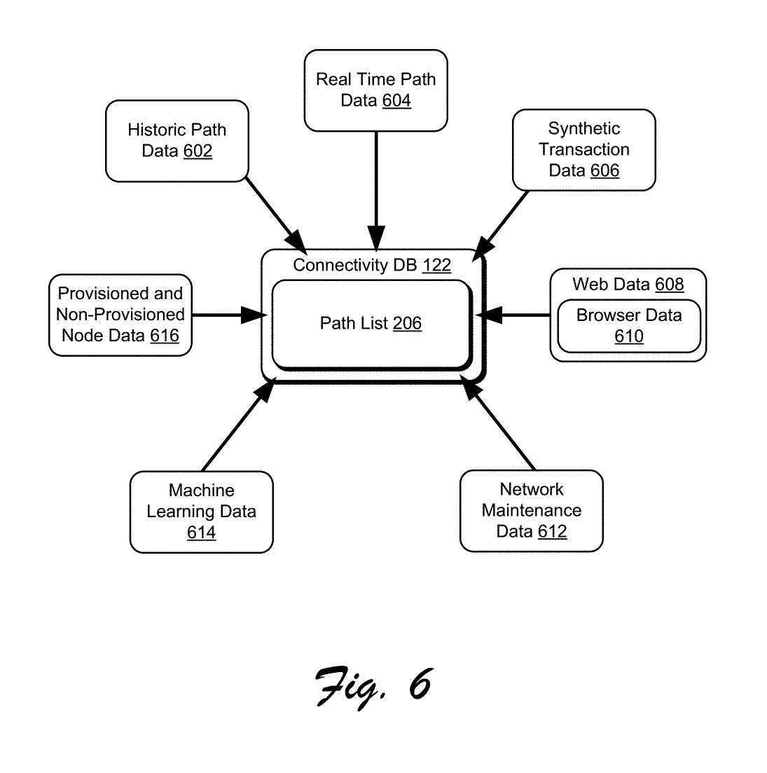

FIG. 6 depicts different sources of communication-related attributes maintained by the connectivity DB 128. Generally, a variety of different types of communication-related attributes can be stored for the different sources, examples of which are discussed above with reference to the communication API 134. Example sources for communication-related attributes stored in the connectivity DB 128 include:

Historic Path Data 602: This type of data includes communication-related attributes for network paths and components of network paths (e.g., intermediate nodes, endpoint devices, and so forth) based on historical usage, such as historical (e.g., past) communication sessions that occurred over the paths and network components.

Real Time Path Data 604: This type of data includes communication-related attributes for network paths and components of network paths (e.g., intermediate nodes, endpoint devices, and so forth) based on current, real time usage. The real time path data 604, for example, can be collected from a component of a network path based on a communication session that is in progress over the network path, e.g., in real time while the communication session is active and in progress.

Synthetic Transaction Data 606: This type of data includes communication-related attributes for network paths and components of network paths (e.g., intermediate nodes, endpoint devices, and so forth) based on synthetic transactions that are implemented over the paths.

Web Data 608: This type of data includes communication-related attributes for network paths and components of network paths (e.g., intermediate nodes, endpoint devices, and so forth) based on data collected from different web-based scenarios and transactions that occur over the paths. For instance, the web data 608 includes browser data 610 collected based on data transmitted and/or received by a web browser. One example of the browser data 610 includes round-trip delay time (RTT) data collected by a web browser and/or other web-enabled functionality. According to various implementations, the web data 608 includes data from historical applications and services that were routed through different routing paths.

Network Maintenance Data 612: This type of data includes communication-related attributes for network paths and components of network paths (e.g., intermediate nodes, endpoint devices, and so forth) based on maintenance procedures performed on the components. For instance, if a particular network component malfunctions and is scheduled for a maintenance procedures, the network maintenance data 612 can be updated to indicate that the component is malfunctioning. Thus, when the connectivity service 126 selects a candidate path for a communication session, the malfunctioning component may be excluded. As another example, when a network component is repaired and/or optimized (e.g., updated), the network maintenance data 612 can be updated to indicate that the network component is functioning and/or has optimized functionality. Thus, when the connectivity service 126 selects a candidate path for a communication session, the repaired/optimized component may be included and/or prioritized for selection for the candidate path.

Machine Learning Data 614: This type of data utilizes machine learning techniques to analyze and characterize attributes of network paths. For instance, one or more of types of communication-related data discussed herein can be aggregated and used to train a predictive model (e.g., a decision tree, a neural network, and so forth) that can then be evaluated to predict performance (e.g., signal quality) of a network node and/or a network path.

Provisioned and Non-Provisioned Node Data 616: This type of data specifies which network nodes 104 are provisioned with the performance module 132, and which network nodes 104 are not provisioned with the performance module 132. For instance, as detailed herein, a network node 104 that is not provisioned with the performance module 132 can be provisioned, either temporarily or for an extended period of time, with the performance module 132. Generally, provisioning a network node 104 with the performance module 132 enables the network node 104 to participate in attribute sharing behaviors, such as for sharing attributes of network paths, communication sessions, and so forth.

The sources and types of communication-related attributes are presented for purpose of example only, and it is to be appreciated that a variety of other types and sources of communication-related attributes can be utilize according to techniques for provisioning a network node for attribute sharing described herein.

Having discussed some example implementation scenarios, consider now a discussion of some example procedures in accordance with one or more implementations.

The following discussion describes some example procedures for provisioning a network node for attribute sharing in accordance with one or more implementations. The example procedures may be employed in the environment 100 of FIG. 1, the system 1300 of FIG. 13, and/or any other suitable environment. The procedures, for instance, represent procedures for implementing aspects of the example implementation scenarios discussed above. In at least some implementations, the steps described for the various procedures can be implemented automatically and independent of user interaction.

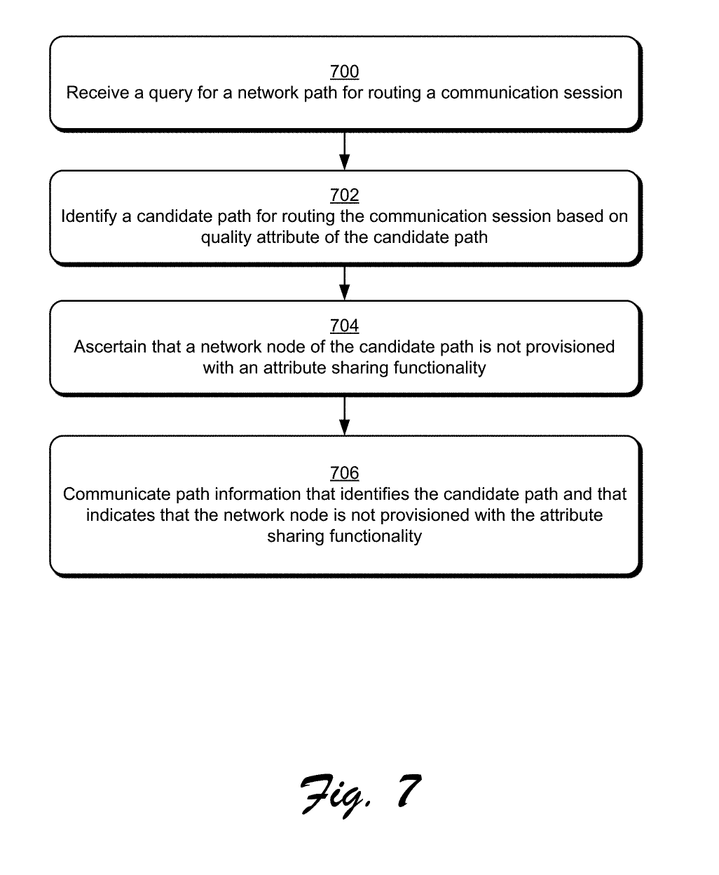

FIG. 7 is a flow diagram that describes steps in a method in accordance with one or more implementations. The method describes an example procedure for providing path information for a communication session in accordance with one or more implementations. In at least some implementations, the method is performed at a network-based service, such as at the communication service 124 and/or the connectivity service 126.

Step 700 receives a query for a network path for routing a communication session. The connectivity service 126, for example, receives a query from the communication service 124 and/or the client device 102 for a routing path for routing a communication session. The query may include various types of information, such as identifiers for the client device 102 and/or the endpoint device 108, and media type(s) to be included in the communication session.

Step 702 identifies a candidate path for routing the communication session based on quality attribute of the candidate path. The connectivity service 126, for example, searches the path list 206 for a candidate routing path with sufficient signal quality for routing the communication session between the client device 102 and the endpoint device 108. As discussed above, the path list 206 identifies different routing paths and quality attributes for the routing paths.

Examples of quality attributes include signal quality, signal strength, error periodicity (e.g., whether errors in the signal are bursty or random), and so forth. Generally, a signal quality of a data stream can be determined in various ways. For instance, the signal quality can be determined based on an error rate (e.g., a bit error rate) detected as part of forward error correction (FEC) decoding. In at least some implementations, for example, a threshold error rate can be defined. Thus, a data stream that exceeds that threshold error rate can be characterized as having a poor signal quality. A data stream that does not exceed the threshold error rate can be characterized as having an acceptable and/or good signal quality.

Additionally or alternatively, signal quality can be determined based on average receive power for the signal. For instance, a data signal that has an average receive power that exceeds a threshold receive power can be characterized as having an acceptable signal quality. However, a data signal that has an average receive power that does not exceed the threshold receive power can be characterized as having a poor signal quality.

Step 704 ascertains that a network node of the candidate path is not provisioned with an attribute sharing functionality. A path record in the path list 206, for example, indicates that an intermediate node 110 and/or the endpoint device 108 are not provisioned with the performance module 132.

Step 706 communicates path information that identifies the candidate path and that indicates that the network node is not provisioned with the attribute sharing functionality. For instance, the connectivity service 126 communicates a notification to the communication service 124 that identifies the candidate path, such as via identifiers for individual network nodes 104 along the candidate path and/or identifiers for networks 106 along the candidate path. Further, the notification identifies a particular network node 104 and/or set of network nodes 104 that are not provisioned with the performance module 132. As detailed elsewhere herein, this causes the communication session to be routed over the candidate path and the network node to be provisioned with the attribute sharing functionality.

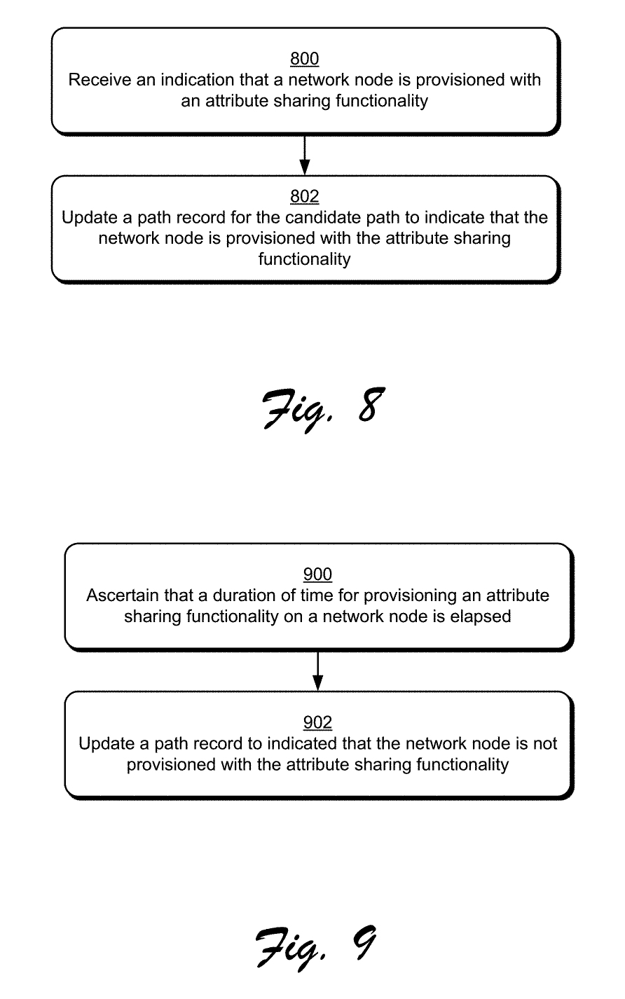

FIG. 8 is a flow diagram that describes steps in a method in accordance with one or more implementations. The method describes an example procedure for updating a path record for a routing path in accordance with one or more implementations. In at least some implementations, the method is performed at a network-based service, such as at the communication service 124 and/or the connectivity service 126.

Step 800 receives an indication that a network node is provisioned with an attribute sharing functionality. The intermediate node 110a and/or the communication service 124, for instance, notifies the connectivity service 126 that the intermediate node 110a and/or the endpoint device 108 is provisioned with the performance module. In at least some implementations, the indication includes a time value indicating a duration of time that the network node is scheduled to be provisioned with the attribute sharing functionality, such as based on the installation policy 302.

Step 802 updates a path record for the candidate path to indicate that the network node is provisioned with the attribute sharing functionality. For example, the connectivity service 126 updates the path record 212 to indicate that the intermediate node 110a is provisioned with the performance module 132. In an implementation where an installation duration is indicated, the connectivity service 126 updates the path record 212 to indicate a duration of time during which the network node is scheduled to be provisioned with the attribute sharing functionality.

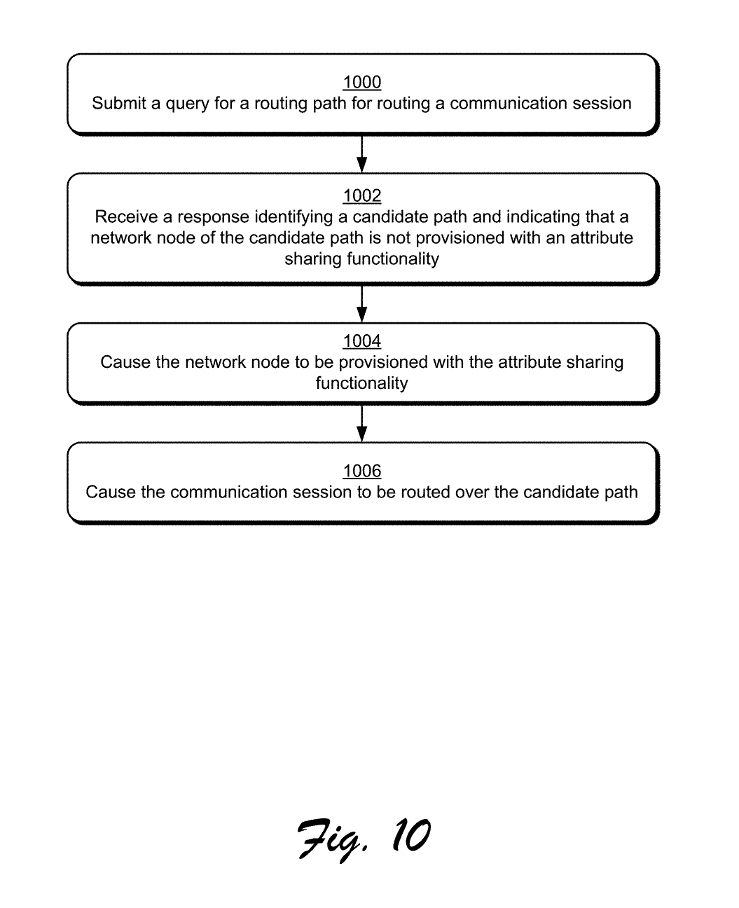

FIG. 9 is a flow diagram that describes steps in a method in accordance with one or more implementations. The method describes an example procedure for updating a path record for a routing path in accordance with one or more implementations. In at least some implementations, the method is performed at a network-based service, such as at the communication service 124 and/or the connectivity service 126.

Step 900 ascertains that a duration of time for provisioning an attribute sharing functionality on a network node is elapsed. The connectivity service 126, for instance, ascertains that a time period during which the performance module 132 is permitted to be installed and/or active on the intermediate node 110a is elapsed.

Step 902 updates a path record to indicated that the network node is not provisioned with the attribute sharing functionality. For instance, the connectivity service 126 updates the path record 212 to indicate that the intermediate node 110a is not provisioned with the performance module 132, such as to reflect that the performance module 132 is uninstalled from and/or deactivated on the intermediate node 110a.

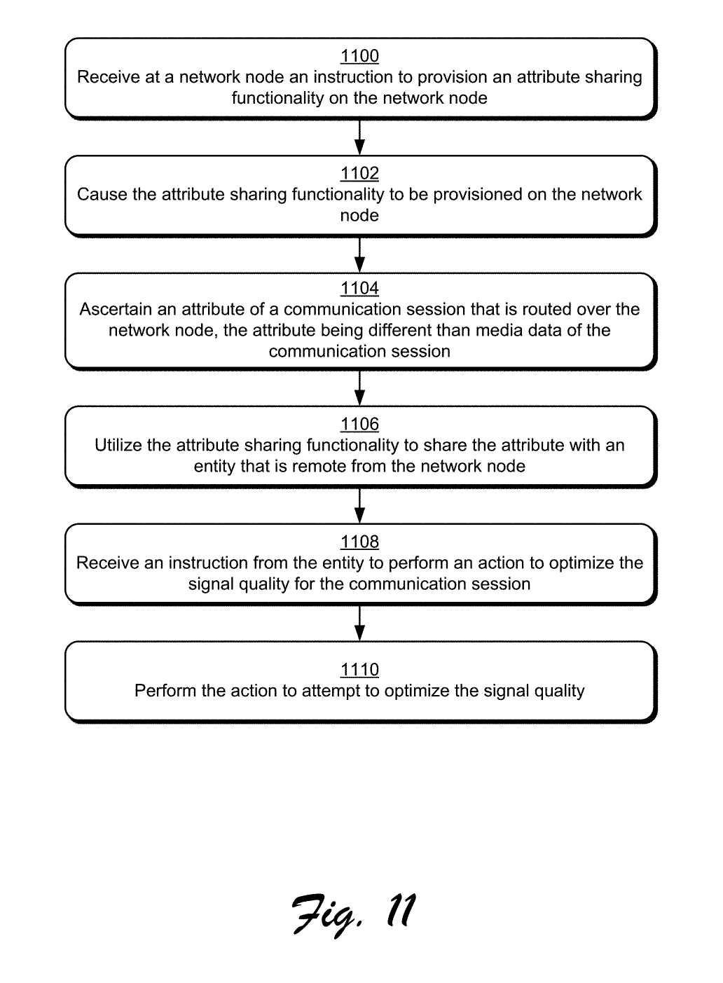

FIG. 10 is a flow diagram that describes steps in a method in accordance with one or more implementations. The method describes an example procedure for causing a network node to be provisioned with attribute sharing functionality in accordance with one or more implementations. In at least some implementations, the method is performed at a network-based service, such as at the communication service 124 and/or the connectivity service 126.

Step 1000 submits a query for a routing path for routing a communication session. The communication service 124, for example, ascertains that the client device 102 requires a routing path for routing a communication session between the client device 102 and the endpoint device 108. Thus, the communication service 124 queries the connectivity service 126 for a routing path.

Step 1002 receives a response identifying a candidate path and indicating that a network node of the candidate path is not provisioned with an attribute sharing functionality. For instance, the communication service 124 receives a response from the connectivity service 126 identifying a candidate path and/or set of candidate paths. Further, the response identifies a network node (e.g., an intermediate node 110 and/or an endpoint device 108) that is not provisioned with the performance module 132.

Step 1004 causing the network node to be provisioned with the attribute sharing functionality. The communication service 124, for example, communicates an instance of the performance module 132 to the intermediate node 110a, along with an instruction to provision the performance module 132. Alternatively, the communication service 124 communicates an instruction to retrieve an instance of the performance module 132 from a remote location. For instance, the communication service 124 can provide the intermediate node 110a with an identifier for a data storage location where the performance module 132 is stored, such as via a Uniform Resource Locator (URL). Accordingly, the intermediate node 110a can access the data storage location, retrieve an instance of the performance module 132, and install the performance module 132.

Step 1006 causes the communication session to be routed over the candidate path. For instance, the communication service 124 notifies the client device 102 of the candidate path, and the client device 102 routes and/or reroutes a communication session over the candidate path.

FIG. 11 is a flow diagram that describes steps in a method in accordance with one or more implementations. The method describes an example procedure for using attribute sharing functionality for sharing an attribute of a communication session in accordance with one or more implementations. In at least some implementations, the method is performed at a network node 104, such as an intermediate node 110 and/or an endpoint device 108.

Step 1100 receives at a network node an instruction to provision an attribute sharing functionality on the network node. The intermediate node 110a, for example, receives an instruction from the communication service 124 to provision the performance module 132 on the intermediate node 110a. In at least some implementations, the instruction includes an instance of the performance module 132, such as executable data that is installable on the intermediate node 110a. Alternatively or additionally, the instruction identifies a network data storage location from which an instance of the performance module 132 can be retrieved.

Step 1102 causes the attribute sharing functionality to be provisioned on the network node. For instance, the intermediate node 110a installs the performance module 132 locally on the intermediate node 110a, such as part of the controller module 112a.

Step 1104 ascertains an attribute of a communication session that is routed over the network node, the attribute being different than media data of the communication session. The performance module 132 executing on the intermediate node 110a, for example, detects various attributes of a communication session that is routed over the intermediate node 110a. Examples of such attributes are discussed above with reference to the communication API 134.

Step 1106 utilizes the attribute sharing functionality to share the attribute with an entity that is remote from the network node. The intermediate node 110a, for example, utilizes the performance module 132 to communicate attributes pertaining to a communication session to a remote entity, such as the communication service 124, the connectivity service 126, and so forth. In at least some implementations, the controller module 112a populates attribute values to various attributes of the communication API 134, and transmits the attributes and corresponding values via the communication API 134 to the remote entity.

Step 1108 receives an instruction from the entity to perform an action to optimize the signal quality for the communication session. The attribute communicated above, for instance, indicates that signal quality for the communication session is degraded, e.g., has fallen below a threshold signal quality. Accordingly, the communication service 124 receives the attribute and provides an instruction to the intermediate node 110a to perform an action to attempt to increase the signal quality.

Step 1110 performs the action to attempt to optimize the signal quality. The intermediate node 110a, for instance, performs the action to attempt to optimize signal quality of a communication session. Examples of the action include changing a setting of the intermediate node 110a, rerouting a communication session through a different routing path, changing an encoding rate for data of the communication session, performing error correction on data of the communication session, and so forth.

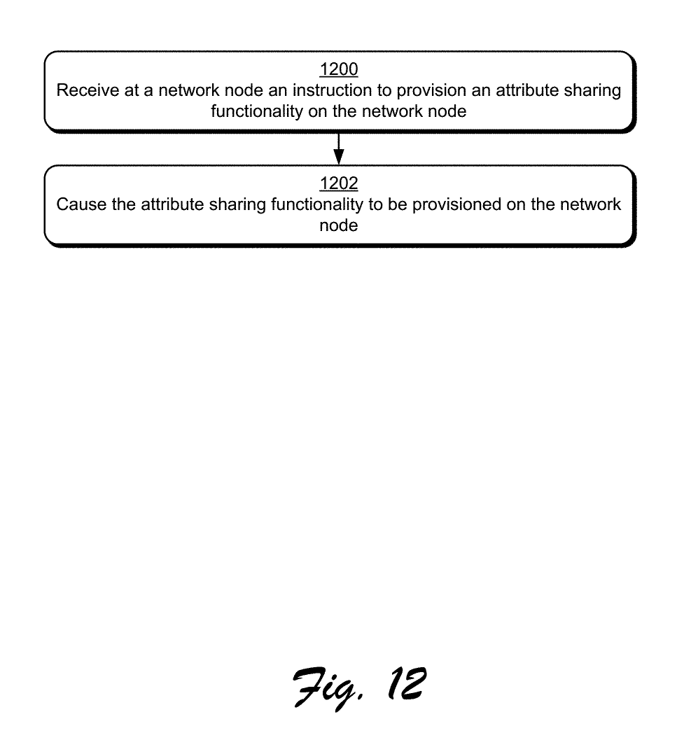

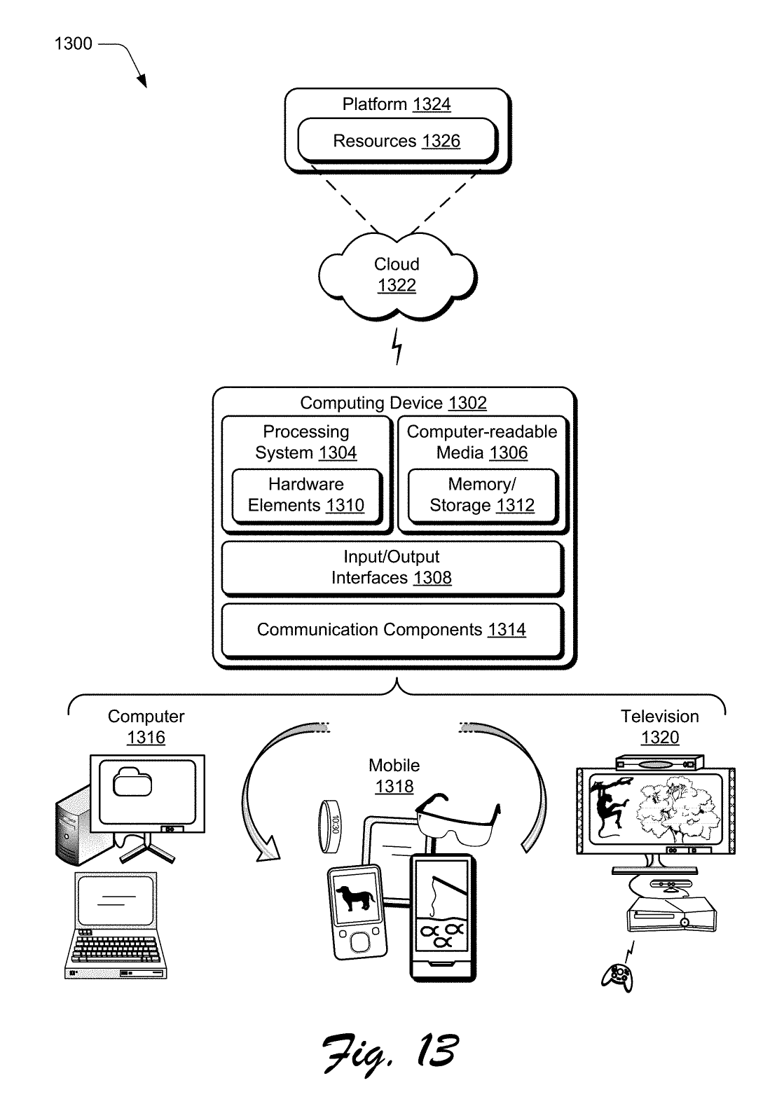

FIG. 12 is a flow diagram that describes steps in a method in accordance with one or more implementations. The method describes an example procedure for deprovisioning an attribute sharing functionality from a network node in accordance with one or more implementations. In at least some implementations, the method is performed at a network node 104, such as an intermediate node 110 and/or an endpoint device 108.

Step 1200 determines that an event occurs that corresponds to a deprovisioning condition for an attribute sharing functionality. The intermediate node 110a, for instance, detects that the event occurs. Examples of the event include an elapsed provisioning time period, a termination of a communication session, user input indicating that the performance module 132 is to be deprovisioned (e.g., uninstalled), and so forth.

Step 1202 deprovisions that attribute sharing functionality. For example, the intermediate node 110a deprovisions the performance module 132, such as by deactivating and/or uninstalling the performance module 132 from the intermediate node 110a.

In one or more implementations, the intermediate node 110a communicates a notification that the performance module 132 is deprovisioned, such as to the communication service 124 and/or the connectivity service 126. This enables information pertaining to the intermediate node 110a to be updated to indicate that the performance module 132 is deprovisioned, such as part of the path record 212.

Accordingly, implementations discussed herein enable attribute sharing functionality to be provisioned to various network nodes such that attributes pertaining to communication sessions across different networks can be shared. The attributes can be used for various purposes, such as optimizing communication session performance, diagnosing network malfunctions, identifying bottleneck along network routing paths, and so forth.

Having discussed some example procedures, consider now a discussion of an example system and device in accordance with one or more implementations.

FIG. 13 illustrates an example system generally at 1300 that includes an example computing device 1302 that is representative of one or more computing systems and/or devices that may implement various techniques described herein. For example, the client device 102, the endpoint device 108, the communication service 124, and/or the connectivity service 126 discussed above with reference to FIG. 1 can be embodied as the computing device 1302. The computing device 1302 may be, for example, a server of a service provider, a device associated with the client (e.g., a client device), an on-chip system, and/or any other suitable computing device or computing system.

The example computing device 1302 as illustrated includes a processing system 1304, one or more computer-readable media 1306, and one or more Input/Output (I/O) Interfaces 1308 that are communicatively coupled one to another. Although not shown, the computing device 1302 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1304 is representative of functionality to perform one or more operations using hardware. Accordingly, the processing system 1304 is illustrated as including hardware element 1310 that may be configured as processors, functional blocks, and so forth. This may include implementation in hardware as an application specific integrated circuit or other logic device formed using one or more semiconductors. The hardware elements 1310 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 1306 is illustrated as including memory/storage 1312. The memory/storage 1312 represents memory/storage capacity associated with one or more computer-readable media. The memory/storage 1312 may include volatile media (such as random access memory (RAM)) and/or nonvolatile media (such as read only memory (ROM), Flash memory, optical disks, magnetic disks, and so forth). The memory/storage 1312 may include fixed media (e.g., RAM, ROM, a fixed hard drive, and so on) as well as removable media (e.g., Flash memory, a removable hard drive, an optical disc, and so forth). The computer-readable media 1306 may be configured in a variety of other ways as further described below.

Input/output interface(s) 1308 are representative of functionality to allow a user to enter commands and information to computing device 1302, and also allow information to be presented to the user and/or other components or devices using various input/output devices. Examples of input devices include a keyboard, a cursor control device (e.g., a mouse), a microphone (e.g., for voice recognition and/or spoken input), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 1302 may be configured in a variety of ways as further described below to support user interaction.

The computing device 1302 further includes communication components 1314, which are representative of functionality to receive and transmit data for the computing device 1302. For instance, the communication components 1314 represent components for interfacing and communicating with a network, such as via any suitable wired and/or wireless protocol. According to various implementations, the communication components 1314 receive data transmitted to the computing device 1302 and route the data to one or more other components of the computing device 1302. Further, the communication components 1314 receive data from one or more internal components of the computing device 1302, and cause the data to be communicated to various entities (e.g., devices) remote from the computing device 1302.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1302. By way of example, and not limitation, computer-readable media may include “computer-readable storage media” and “computer-readable signal media.”

“Computer-readable storage media” may refer to media and/or devices that enable persistent storage of information in contrast to mere signal transmission, carrier waves, or signals per se. Computer-readable storage media do not include signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1302, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared, and other wireless media.

As previously described, hardware elements 1310 and computer-readable media 1306 are representative of instructions, modules, programmable device logic and/or fixed device logic implemented in a hardware form that may be employed in some implementations to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 1310. The computing device 1302 may be configured to implement particular instructions and/or functions corresponding to the software and/or hardware modules. Accordingly, implementation of modules that are executable by the computing device 1302 as software may be achieved at least partially in hardware, e.g., through use of computer-readable storage media and/or hardware elements 1310 of the processing system. The instructions and/or functions may be executable/operable by one or more articles of manufacture (for example, one or more computing devices 1302 and/or processing systems 1304) to implement techniques, modules, and examples described herein.

As further illustrated in FIG. 13, the example system 1300 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 1300, multiple devices are interconnected through a central computing device. The central computing device may be local to the multiple devices or may be located remotely from the multiple devices. In one implementation, the central computing device may be a cloud of one or more server computers that are connected to the multiple devices through a network, the Internet, or other data communication link.

In one implementation, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one implementation, a class of target devices is created and experiences are tailored to the generic class of devices. A class of devices may be defined by physical features, types of usage, or other common characteristics of the devices.

In various implementations, the computing device 1302 may assume a variety of different configurations, such as for computer 1316, mobile 1318, and television 1320 uses. Each of these configurations includes devices that may have generally different constructs and capabilities, and thus the computing device 1302 may be configured according to one or more of the different device classes. For instance, the computing device 1302 may be implemented as the computer 1316 class of a device that includes a personal computer, desktop computer, a multi-screen computer, laptop computer, netbook, and so on.

The computing device 1302 may also be implemented as the mobile 1318 class of device that includes mobile devices, such as a mobile phone, portable music player, portable gaming device, a tablet computer, a wearable device, a multi-screen computer, and so on. The computing device 1302 may also be implemented as the television 1320 class of device that includes devices having or connected to generally larger screens in casual viewing environments. These devices include televisions, set-top boxes, gaming consoles, and so on.

The techniques described herein may be supported by these various configurations of the computing device 1302 and are not limited to the specific examples of the techniques described herein. For example, functionalities discussed with reference to the communication service 124 and the connectivity service 126 may be implemented all or in part through use of a distributed system, such as over a “cloud” 1322 via a platform 1324 as described below.

The cloud 1322 includes and/or is representative of a platform 1324 for resources 1326. The platform 1324 abstracts underlying functionality of hardware (e.g., servers) and software resources of the cloud 1322. The resources 1326 may include applications and/or data that can be utilized while computer processing is executed on servers that are remote from the computing device 1302. Resources 1326 can also include services provided over the Internet and/or through a subscriber network, such as a cellular or Wi-Fi network.

The platform 1324 may abstract resources and functions to connect the computing device 1302 with other computing devices. The platform 1324 may also serve to abstract scaling of resources to provide a corresponding level of scale to encountered demand for the resources 1326 that are implemented via the platform 1324. Accordingly, in an interconnected device implementation, implementation of functionality described herein may be distributed throughout the system 1300. For example, the functionality may be implemented in part on the computing device 1302 as well as via the platform 1324 that abstracts the functionality of the cloud 1322.

Discussed herein are a number of methods that may be implemented to perform techniques discussed herein. Aspects of the methods may be implemented in hardware, firmware, or software, or a combination thereof. The methods are shown as a set of steps that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods can be implemented via interaction between various entities discussed above with reference to the environment 100.

Techniques for provisioning a network node for attribute sharing are described. Although implementations are described in language specific to structural features and/or methodological acts, it is to be understood that the implementations defined in the appended claims are not necessarily limited to the specific features or acts described. Rather, the specific features and acts are disclosed as example forms of implementing the claimed implementations.

In the discussions herein, various different implementations are described. It is to be appreciated and understood that each implementation described herein can be used on its own or in connection with one or more other implementations described herein. Further aspects of the techniques discussed herein relate to one or more of the following implementations.

A system for determining path information for routing a communication session, the system comprising: at least one processor; and one or more computer-readable storage media including instructions stored thereon that, responsive to execution by the at least one processor, cause the system perform operations including: receiving a query for a network path for routing a communication session; identifying a candidate path for routing the communication session based on quality attribute of the candidate path; ascertaining that a network node of the candidate path is not provisioned with an attribute sharing functionality; and communicating path information that identifies the candidate path and that indicates that the network node is not provisioned with the attribute sharing functionality to cause the communication session to be routed over the candidate path and the network node to be provisioned with the attribute sharing functionality.

In addition to any of the above described systems, any one or combination of: wherein the query is received after initiation of the communication session, or prior to initiation of the communication session; wherein the query is received at a cloud database that stores information for routing paths based on historical communication sessions and an attribute of a current active communication session; wherein the query is received at a cloud database that stores information for routing paths based on historical applications and services that were routed through the routing paths; wherein the network node comprises an intermediate node along the candidate path; wherein the operations further include: receiving an indication that the network node is provisioned with the attribute sharing functionality; and updating a path record for the candidate path to indicate that the network node is provisioned with the attribute sharing functionality; wherein the operations further include: receiving an indication that the network node is provisioned with the attribute sharing functionality and a time value indicating a duration of time that the network node is scheduled to be provisioned with the attribute sharing functionality; and updating a path record for the candidate path to indicate that the network node is provisioned with the attribute sharing functionality and the duration of time that the network node is scheduled to be provisioned with the attribute sharing functionality; wherein the operations further include: receiving an indication that the network node is provisioned with the attribute sharing functionality and a time value indicating a duration of time that the network node is scheduled to be provisioned with the attribute sharing functionality; updating a path record for the candidate path to indicate that the network node is provisioned with the attribute sharing functionality and the duration of time that the network node is scheduled to be provisioned with the attribute sharing functionality; ascertaining that the duration of time is elapsed; and updating the path record to indicated that the network node is not provisioned with the attribute sharing functionality; wherein the operations further include: receiving a further quality attribute of the candidate path from the network node; and updating a path record for the candidate path with the further quality attribute; wherein the operations further include: receiving a further quality attribute of the candidate path based on web data collected over the candidate path; and updating a path record for the candidate path with the further quality attribute.

A computer-implemented method for determining path information for routing a communication session, the method comprising: submitting a query for a routing path for routing a communication session; receiving a response identifying a candidate path and indicating that a network node of the candidate path is not provisioned with an attribute sharing functionality; causing the network node to be provisioned with the attribute sharing functionality; and causing the communication session to be routed over the candidate path.

In addition to any of the above described methods, any one or combination of: wherein said causing the network node to be provisioned with the attribute sharing functionality comprises communicating an instance of the attribute sharing functionality to the network node; wherein said causing the network node to be provisioned with the attribute sharing functionality is performed prior to initiation of the communication session; wherein said causing the network node to be provisioned with the attribute sharing functionality is performed after initiation of the communication session; wherein said causing the communication session to be routed over the candidate path comprises communicating a path notification that identifies the candidate path to a client device associated with the communication session.

A computer-implemented method for provisioning a network node with attribute sharing functionality, the method comprising: receiving at a network node an instruction to provision an attribute sharing functionality on the network node; causing the attribute sharing functionality to be provisioned on the network node; ascertaining an attribute of a communication session that is routed over the network node, the attribute being different than media data of the communication session; and utilizing the attribute sharing functionality to share the attribute with an entity that is remote from the network node.

In addition to any of the above described methods, any one or combination of: wherein said causing the attribute sharing functionality to be provisioned on the network node comprises provisioning the attribute sharing functionality on the network node subject to a provisioning policy that specifies a permitted duration of provisioning for the attribute sharing functionality; wherein the attribute of the communication session comprises an indication of signal quality for the communication session detected at the network node; wherein said causing the attribute sharing functionality to be provisioned on the network node comprises provisioning the attribute sharing functionality on the network node subject to a provisioning policy that specifies a permitted duration of provisioning for the attribute sharing functionality, and wherein the method further deprovisioning the attribute sharing functionality when the permitted duration of provisioning is elapsed; wherein the attribute of the communication session comprises an indication of signal quality for the communication session detected at the network node, and wherein the method further comprises: receiving an instruction from the entity to perform an action to optimize the signal quality for the communication session; and performing the action to attempt to optimize the signal quality.

What is claimed is:

1. A system comprising:
at least one processor; and
one or more computer-readable storage media including instructions stored thereon that, responsive to execution by the at least one processor, cause the system perform operations including:
receiving a query for a network path for routing a communication session;
identifying a candidate path for routing the communication session based on quality attribute of the candidate path;
ascertaining that a network node of the candidate path is not provisioned with an attribute sharing functionality; and
communicating path information that identifies the candidate path and that indicates that the network node is not provisioned with the attribute sharing functionality to cause the communication session to be routed over the candidate path and the network node to be provisioned with the attribute sharing functionality.

2. A system as recited in claim 1, wherein the query is received after initiation of the communication session, or prior to initiation of the communication session.

3. A system as recited in claim 1, wherein the query is received at a cloud database that stores information for routing paths based on historical communication sessions and an attribute of a current active communication session.

4. A system as recited in claim 1, wherein the query is received at a cloud database that stores information for routing paths based on historical applications and services that were routed through the routing paths.

5. A system as recited in claim 1, wherein the network node comprises an intermediate node along the candidate path.

6. A system as recited in claim 1, wherein the operations further include:
receiving an indication that the network node is provisioned with the attribute sharing functionality; and
updating a path record for the candidate path to indicate that the network node is provisioned with the attribute sharing functionality.

7. A system as recited in claim 1, wherein the operations further include:
receiving an indication that the network node is provisioned with the attribute sharing functionality and a time value indicating a duration of time that the network node is scheduled to be provisioned with the attribute sharing functionality; and
updating a path record for the candidate path to indicate that the network node is provisioned with the attribute sharing functionality and the duration of time that the network node is scheduled to be provisioned with the attribute sharing functionality.

8. A system as recited in claim 1, wherein the operations further include:
receiving an indication that the network node is provisioned with the attribute sharing functionality and a time value indicating a duration of time that the network node is scheduled to be provisioned with the attribute sharing functionality;
updating a path record for the candidate path to indicate that the network node is provisioned with the attribute sharing functionality and the duration of time that the network node is scheduled to be provisioned with the attribute sharing functionality;
ascertaining that the duration of time is elapsed; and
updating the path record to indicated that the network node is not provisioned with the attribute sharing functionality.

9. A system as recited in claim 1, wherein the operations further include:
receiving a further quality attribute of the candidate path from the network node; and
updating a path record for the candidate path with the further quality attribute.

10. A system as recited in claim 1, wherein the operations further include:
receiving a further quality attribute of the candidate path based on web data collected over the candidate path; and
updating a path record for the candidate path with the further quality attribute.

11. A computer-implemented method comprising:
submitting a query for a routing path for routing a communication session;
receiving a response identifying a candidate path and indicating that a network node of the candidate path is not provisioned with an attribute sharing functionality;
causing the network node to be provisioned with the attribute sharing functionality; and
causing the communication session to be routed over the candidate path.

12. A method as recited in claim 11, wherein said causing the network node to be provisioned with the attribute sharing functionality comprises communicating an instance of the attribute sharing functionality to the network node.

13. A method as recited in claim 11, wherein said causing the network node to be provisioned with the attribute sharing functionality is performed prior to initiation of the communication session.

14. A method as recited in claim 11, wherein said causing the network node to be provisioned with the attribute sharing functionality is performed after initiation of the communication session.

15. A method as recited in claim 11, wherein said causing the communication session to be routed over the candidate path comprises communicating a path notification that identifies the candidate path to a client device associated with the communication session.

16. A computer-implemented method comprising:
receiving at a network node an instruction to provision an attribute sharing functionality on the network node;
causing the attribute sharing functionality to be provisioned on the network node;
ascertaining an attribute of a communication session that is routed over the network node, the attribute being different than media data of the communication session; and
utilizing the attribute sharing functionality to share the attribute with an entity that is remote from the network node.

17. A method as described in claim 16, wherein said causing the attribute sharing functionality to be provisioned on the network node comprises provisioning the attribute sharing functionality on the network node subject to a provisioning policy that specifies a permitted duration of provisioning for the attribute sharing functionality.

18. A method as described in claim 16, wherein the attribute of the communication session comprises an indication of signal quality for the communication session detected at the network node.

19. A method as described in claim 16, wherein said causing the attribute sharing functionality to be provisioned on the network node comprises provisioning the attribute sharing functionality on the network node subject to a provisioning policy that specifies a permitted duration of provisioning for the attribute sharing functionality, and wherein the method further deprovisioning the attribute sharing functionality when the permitted duration of provisioning is elapsed.

20. A method as described in claim 16, wherein the attribute of the communication session comprises an indication of signal quality for the communication session detected at the network node, and wherein the method further comprises:
receiving an instruction from the entity to perform an action to optimize the signal quality for the communication session; and
performing the action to attempt to optimize the signal quality.
